(19) United States
(12) Patent Application Publication
(10) Pub. No.: US 2016/0186943 A1
(43) Pub. Date: Jun. 30, 2016

(54) BUILDING DECORATIVE LIGHTING KIT

(71) Applicant: Richard Joseph Pierre Howard, West Kelowna (CA)

(72) Inventor: Richard Joseph Pierre Howard, West Kelowna (CA)

(21) Appl. No.: 14/582,933

(22) Filed: Dec. 24, 2014

(51) Int. Cl. F21S 8/00; F21V 21/088

(52) U.S. Cl. CPC F21S 8/036; F21V 21/088; F21W 2121/004

(57) ABSTRACT

A kit for locating decorative lighting on a building comprising a base bracket securable to a vertical surface of the building having a channel sized and shaped to contain an elongate lighting source. The kit further comprises a distal end brace securable to the building at a location distal to the base bracket and a pliable panel having a reflective surface thereon. The flexible panel extends between first and second edges wherein the first edge is adapted to engage with the distal end brace and wherein the second edge is adapted to engage within the channel of the base bracket between a position for the lighting source and the wall of the building.

### BACKGROUND OF THE INVENTION

1. Field of Invention

The present invention relates to lighting in general and in particular to a kit for securing decorative illumination to a building.

2. Description of Related Art

Decorative illumination is commonly applied to the exterior of buildings for ongoing decoration or for special occasions such as Christmas or the like. In particular, Christmas lights are commonly applied to the building around the exterior perimeter thereof at locations where they can be easily placed and removed after the desired season is over.

One common method of applying Christmas lights is to secure a string of commonly available light emitting diode (LED) or incandescent bulbs to edges of gutters, eves troughs or a the fascia board of the roof. One disadvantage of conventional Christmas lights is that as they are only utilized for a portion of the calendar year, home owners have the decision to either leave them attached to their house all year or install and remove them each Christmas season. Many users feel that leaving Christmas lights up all year is visually unappealing or unattractive.

Disadvantageously, the application of Christmas or other decorative lights to a building exterior on an annual basis may cause a potential safety risk due to the need to commonly stand on a step or extension ladder or other elevated platform to reach the desired location for placement of the lights.

### SUMMARY OF THE INVENTION

According to a first embodiment of the present invention there is disclosed a kit for locating decorative lighting on a building comprising a base bracket securable to a vertical surface of the building having a channel sized and shaped to contain an elongate lighting source. The kit further comprises a distal end brace securable to the building at a location distal to the base bracket and a pliable panel having a reflective surface thereon. The flexible panel extends between first and second edges wherein the first edge is adapted to engage with the distal end brace and wherein the second edge is adapted to engage within the channel of the base bracket between a position for the lighting source and the wall of the building.

The distal end bracket may be adapted to be secured to the vertical surface of the building. The distal end bracket may be adapted to be secured to a downwardly oriented horizontal surface of the building at a location above the base bracket. The base bracket may be formed of sheet metal. The pliable panel may be formed of sheet metal.

The distal bracket may be formed of a block around which the first edge of the pliable panel extends. The distal bracket may be formed of sheet metal. The distal bracket and the bases bracket may be formed of a continuous sheet.

The continuous sheet is formed of a horizontal portion extending from the distal end brace and a vertical portion extending from the base bracket. The continuous sheet may include a truncating section between the horizontal and vertical portions.

The channel may include a light retaining portion and a slot between the light retaining portion and a wall engaging portion. The slot may be sized to receive the second edge of the pliable panel. The slot may include a retaining block therein which is fastenable to the wall with fasteners.

The apparatus may further comprise a plurality of clips adapted to be secured to the elongate lighting source wherein the plurality of clips are adapted to be secured within the channel.

Each clip may include a clamping portion and a retaining portion adapted to be frictionally engaged within the channel. The clamping portion may be perpendicular to the retaining portion. The clamping portion may be parallel to the retaining portion. The clip may have a substantially n-shaped cross section.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an exterior of a building having an illuminating assembly according to a first embodiment of the present invention.

FIG. 2 is a detailed perspective view of the illuminating assembly of FIG. 1.

FIG. 3 is a cross sectional view of the illuminating assembly of FIG. 1 as taken along the line 3-3 according to a first embodiment of the present invention.

FIG. 4 is a cross sectional view of the illuminating assembly of FIG. 1 as taken along the line 3-3 according to a further embodiment of the present invention.

FIG. 5a is a side view of the reflective pliable panel of the apparatus of FIG. 1 according to a first embodiment.

FIG. 5b is a side view of the reflective pliable panel of the apparatus of FIG. 1 according to a further embodiment.

FIG. 6 is a side view of the reflective pliable panel of the apparatus of FIG. 1 at an intermediate stage of installation.

FIG. 7a is a perspective view of the light retaining clip of the apparatus of FIG. 1 according to a first embodiment.

FIG. 7b is a is a perspective view of the light retaining clip of the apparatus of FIG. 1 according to a first embodiment.

FIG. 8 is an inside corner cap for use on the illuminating assembly of FIG. 1.

FIG. 9 is an outside corner cap for use on the illuminating assembly of FIG. 1.

FIG. 10 is an end cap for use on the illuminating assembly of FIG. 1.

FIG. 11 is a cross sectional view of an illuminating assembly according to a further embodiment of the present invention.

FIG. 12 is a cross sectional view of an illuminating assembly according to a further embodiment of the present invention.

FIG. 13 is a cross sectional view of an illuminating assembly according to a further embodiment of the present invention.

FIG. 14 is a cross sectional view of an illuminating assembly according to a further embodiment of the present invention.

FIG. 15 is a cross sectional view of an illuminating assembly according to a further embodiment of the present invention.

FIG. 16 is a cross sectional view of an illuminating assembly according to a further embodiment of the present invention.

### DETAILED DESCRIPTION

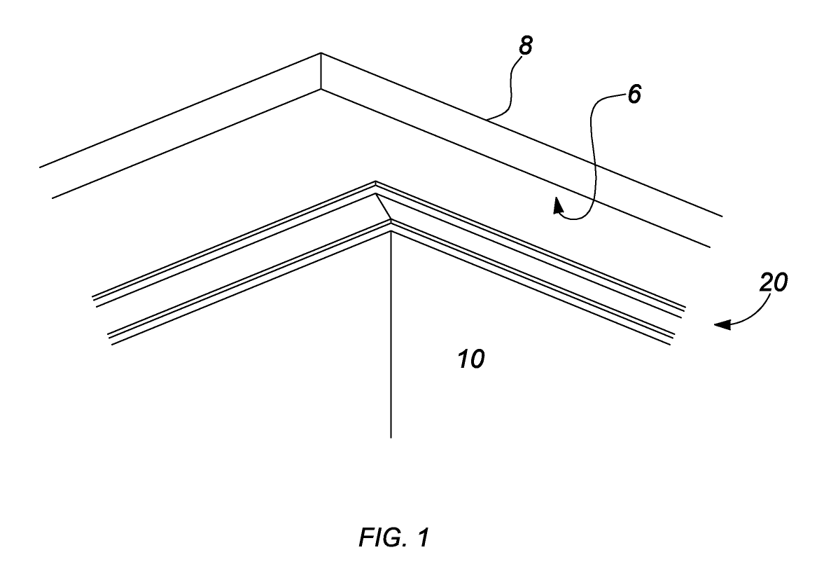

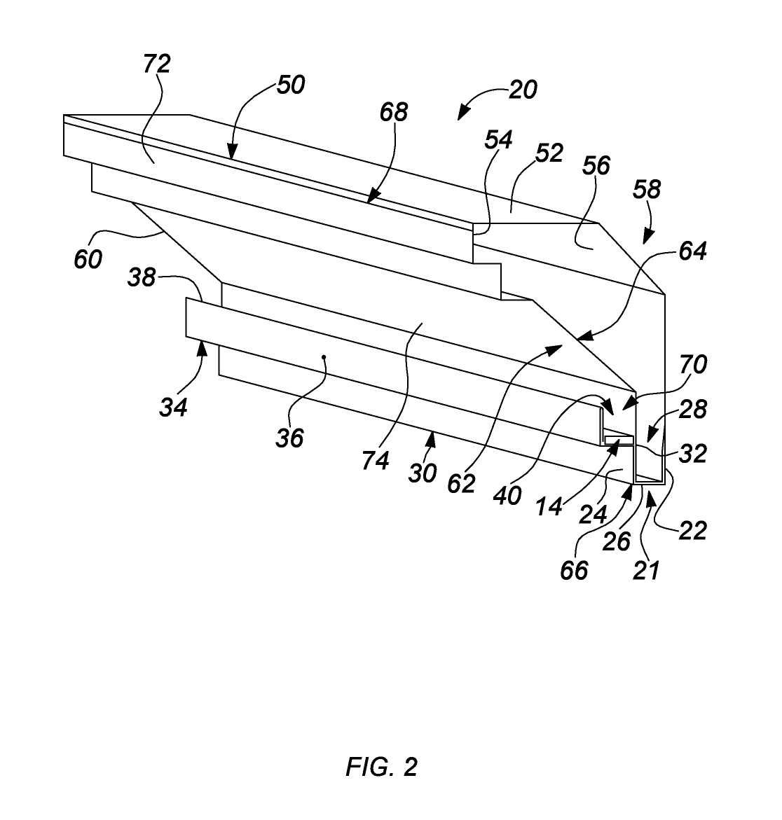

Referring to FIG. 1, an exterior of a building 4 is illustrated having an apparatus for providing illumination therearound according to a first embodiment of the invention is shown generally at 20. As illustrated in FIG. 1, the apparatus 20 may be applied around an exterior of a building and adapted to contain an elongate lighting source 14 (not shown in FIG. 1) such as, by way of non-limiting example, string lights, light emitting diode (LED) lights or the like. Although the apparatus 20 is illustrated around a building exterior in FIG. 1, it will be appreciated that it may be applied at other locations as well such as, by way of non-limiting example, interior lighting, around windows and doors. As illustrated in FIG. 1, the building includes a wall or vertical surface and an eave or horizontal surface wherein the apparatus 20 may be applied at the intersection thereof. As illustrated in FIGS. 1 and 2, the apparatus is formed of a base bracket 21 applied to the wall 10 and a corresponding distal end bracket 50 applied to the underside of the vertical surface and a pliable panel 60 extending therebetween adapted to reflect light produced by the elongate lighting source 14 for indirect viewing.

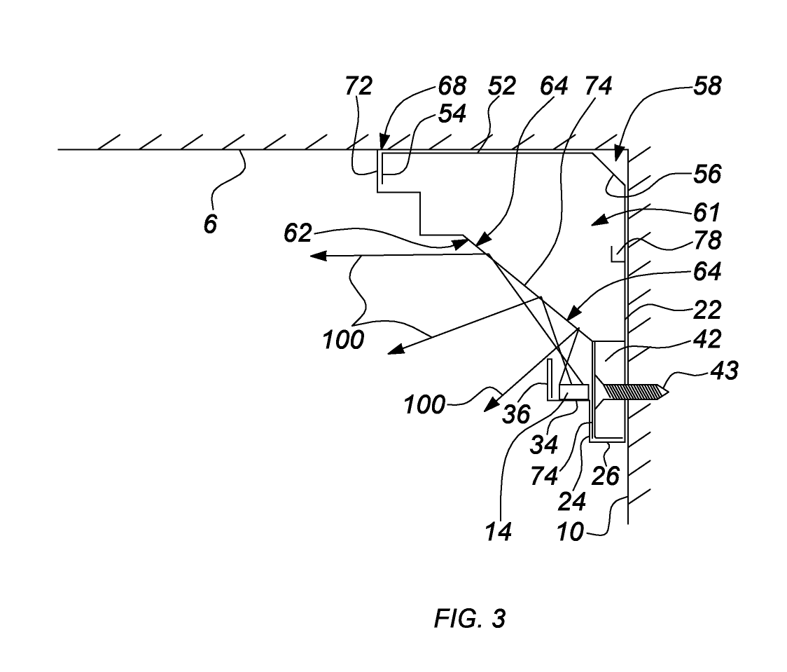

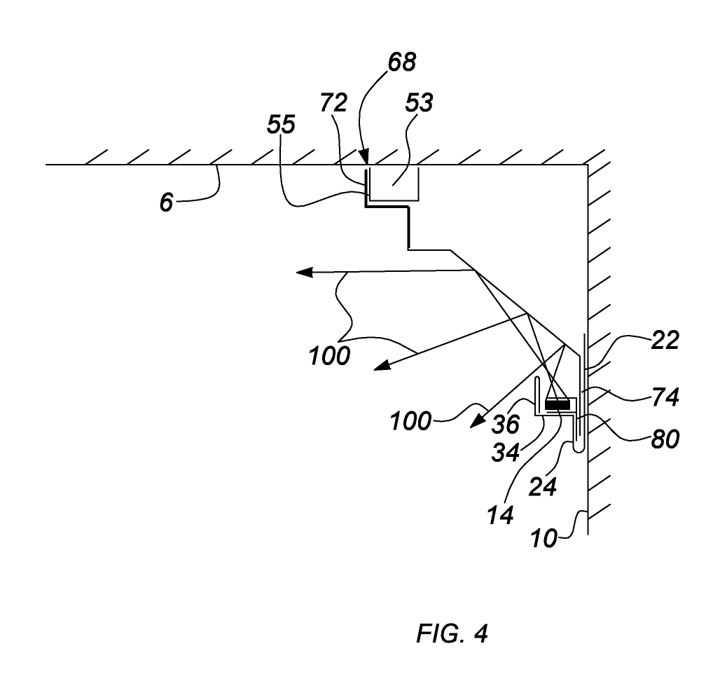

Turning now to FIG. 2, a perspective view of the apparatus is shown. The base bracket 21 is formed of a rear panel 22, a front panel 24 and a base panel 26. The front and rear panels 24 and 22 are arranged in parallel spaced apart relation with the base panel spacing them apart so as to form a bottom channel 28 therein. The front panel 24 extends between bottom and top edges, 30 and 32, respectively the base bracket 21 further includes a jog panel 34 extending from the top edge 32 of the front panel 24. The jog panel 34 extends substantially perpendicularly to the front panel 24 to a guard panel 36 at a distal edge thereof. The jog panel 34 and guard panel 36 form a light channel 40 therein sized to receive the elongate lighting source 14 therein. As illustrated in FIGS. 2 and 3, the bottom channel may be sized to receive a block 42 therein so as to facilitate installation by providing an enlarged surface to secure fasteners 43 through. In particular, the base panel 26 is selected to correspond to the desired width of the block 42, such as, by way of non-limiting example, up to 1.5 inches (38 mm). Optionally, as illustrated in FIG. 4, the base panel 26 may be omitted thereby positioning the front and rear panels 24 and 22 proximate to each other thereby omitting the block 42 as well. Also as illustrated in FIG. 4, the distal end bracket 50 may comprise a block 53 or other body providing an end surface 55 upon which the pliable panel 60 may be engaged.

The distal end bracket 50 is secured to the underside of the horizontal surface 6 such as an eave or the like. As illustrated in FIGS. 2 and 3, the distal end bracket comprises a top panel 52 securable to the horizontal surface 6 and an end panel 54 extending perpendicularly downward therefrom. As illustrated in FIGS. 2 and 3, the distal end bracket 50 may be co-formed with the base bracket 21 from a common sheet of material, such as, by way of non-limiting example, sheet metal, plastic or the like. Optionally each of the distal end bracket 50 and base brackets 21 may be formed independently of each other. Where the base bracket 21 and distal end bracket 50 are co-formed with each other, the top panel 52 and rear panel 22 are each extended towards each other until they intersect. Optionally, the top panel 52 and rear panel 22 may include a chamfer panel 56 extending diagonally therebetween so as to provide a void region 58 therebehind. It will be appreciated that the inclusion of the chamfer panel 56 permits the void region 58 to contain imperfections in the corner of the building and/or wiring and other hardware therein.

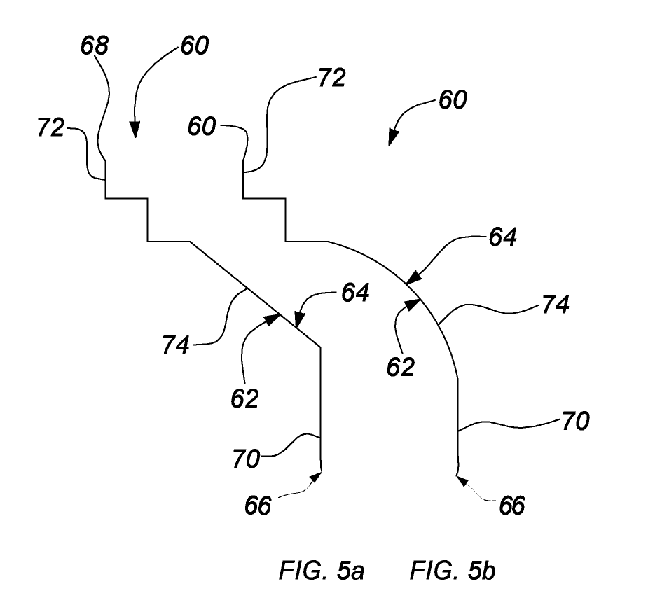

The pliable panel 60 comprises an elongate member having front and rear surfaces, 62 and 64, respectively and first and second edges, 66 and 68, respectively. The pliable panel 60 includes a first engaging portion 70 proximate to the first edge 66 and a second engaging portion 72 proximate to the second edge with a reflecting portion 74 therebetween. The first engaging portion is oriented to be perpendicular to the horizontal surface 6 so as to be engageable over the distal end bracket 50. The second engaging surface is oriented to be parallel to the rear panel 22 of the base bracket 21 so as to be engageable within the bottom channel 28. The front surface 62 of the reflecting portion 74 has a reflective or partially reflective surface thereon so as to be operable to reflect light from the elongate lighting source 14. The reflecting surface may be formed by the reflectiveness of the pliable panel itself or may optionally comprise an applied surface treatment material such as a reflective tape paint or the like as are commonly known. Optionally, the reflective surface may include a texturing or roughening treatment as are commonly known so as to scatter or otherwise reflect the light in a diffuse manner as is commonly known. As illustrated in FIG. 2 and FIG. 5a, the reflecting portion 74 may have a substantially planar shape, although it will be appreciated that any other shape may also be utilized such as arcuate as illustrated in FIG. 5b.

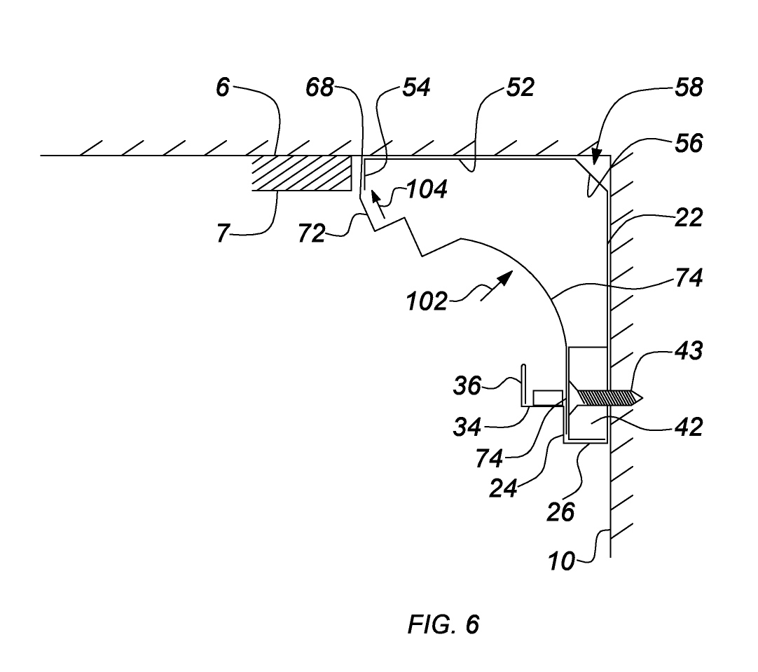

As illustrated in FIG. 6, in operation, the base bracket 21 and distal end bracket 50 may be secured to vertical and horizontal surfaces 10 and 6 of the building. Thereafter, the second engaging portion 72 of the pliable panel 60 may be engaged within the bottom channel 28 and the remainder thereof bent or otherwise plastically deformed in a direction generally indicated at 102 so as to position the second edge 68 thereof at a position that can be inserted into the gap between the end panel 54 and a soffit panel 7 as illustrated. The first engaging portion 72 may then be inserted into such gap in a direction illustrated at 104 so as to securely locate the pliable panel 60 in the position illustrated in FIGS. 2 and 3. Optionally, tabs 78 or other mounting structures may be provided from the rear panel 22 or another location to permit the installation of electrical control for the lights and the like as are commonly known.

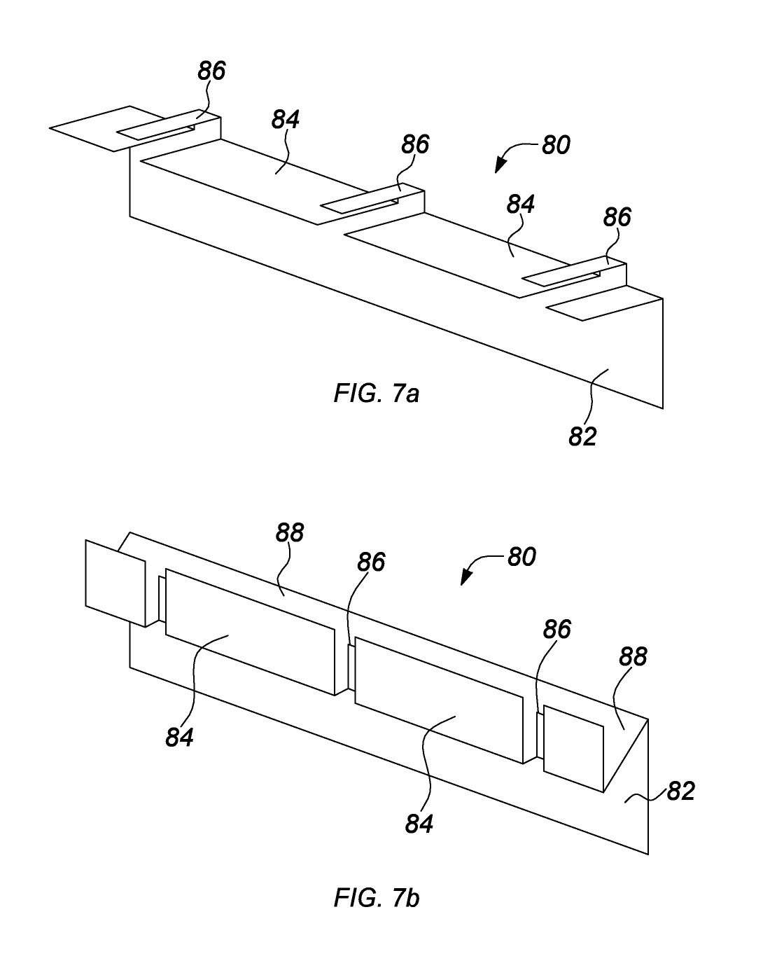

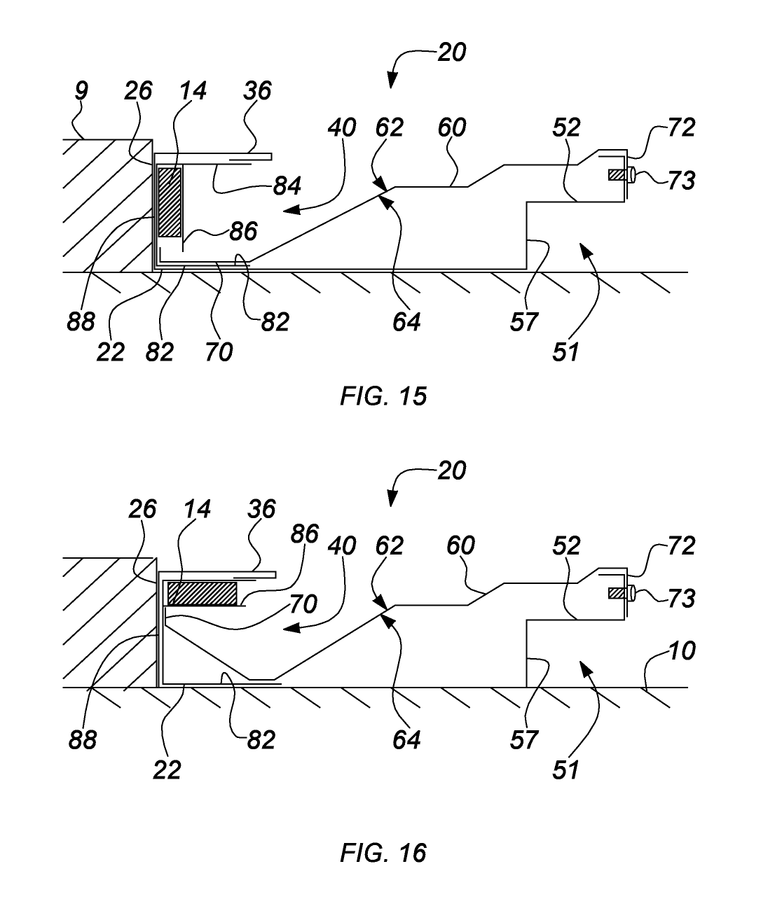

As illustrated in FIG. 4, the apparatus may optionally include light holding clips 80 adapted to retain and support the elongate light sources within the bottom channel. Although the clips 80 are illustrated as being utilized with the embodiment of FIG. 4, it will also be appreciated that such clips may be used with the other embodiments disclosed herein as well. Alternatively, the elongate light sources may be secured within the channel through the use of fasteners, adhesives or the like as are commonly known. As illustrated in FIGS. 7a and 7b, the clips 80 are formed of a base panel 82 and include a supporting panel 84 with a plurality of clip panels 86 extending therefrom. As The supporting panel 84 and clip panels 86 are substantially parallel to each other and are spaced apart by a distance selected to frictionally retain the elongate light sources therein. The base panel 82 is sized to be received within the bottom channel 28 with a height selected to securely locate the elongate lighting source 14 therein as illustrated in FIGS. 2 and 3. As illustrated in FIG. 7a, the supporting panel 84 may extend perpendicularly from the base panel 82 so as to orient the elongate lighting source 14 perpendicularly thereto along the bottom of the light channel 40 as illustrated in FIG. 2. Optionally, the clip 80 may include a jog panel 88 extending diagonally between the base panel 82 and the supporting panel 84 such that the clip 80 has an n-shaped cross section as illustrated in FIG. 7b. In such embodiments, the elongate lighting source 14 will be located along one of the sides of the light channel 40. Optionally, the jog panel 88 may also have a reflective surface thereon to reflect light from an elongate lighting sources 14 applied proximate to the guard panel 36. As illustrated in FIGS. 15 and 16, the jog panel 88 may extend perpendicularly between the base panel 82 and the supporting panel 84 so as to form a u-shaped clip.

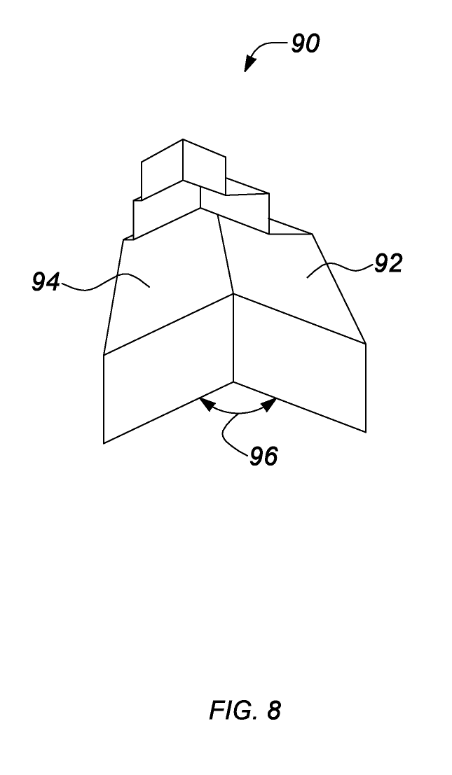

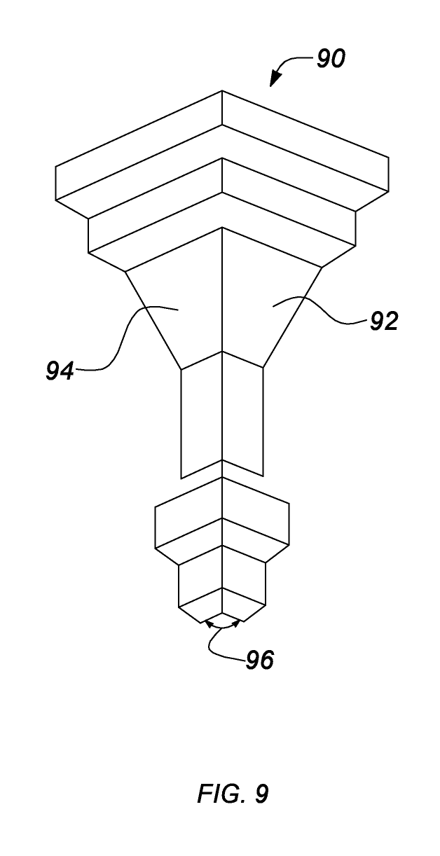

It will be appreciated that when located around a building exterior, it may be desirable to extend the apparatus around inside and outside corners occurring on the building. In such locations, corner caps 90 may be utilized as illustrated in FIGS. 8 (showing a cap for an inside corner) and FIG. 9 (showing a cap for an outside corner). As illustrated, the corner caps 90 are formed of first and second panels, 92 and 94, respectively having outlines corresponding to the side profile of the base bracket 21, distal end bracket 50 and pliable panel 60 with an angle, generally indicated at 96 therebetween. It will be appreciated that the angle 96 may be selected to be any angle corresponding to the corner of the building.

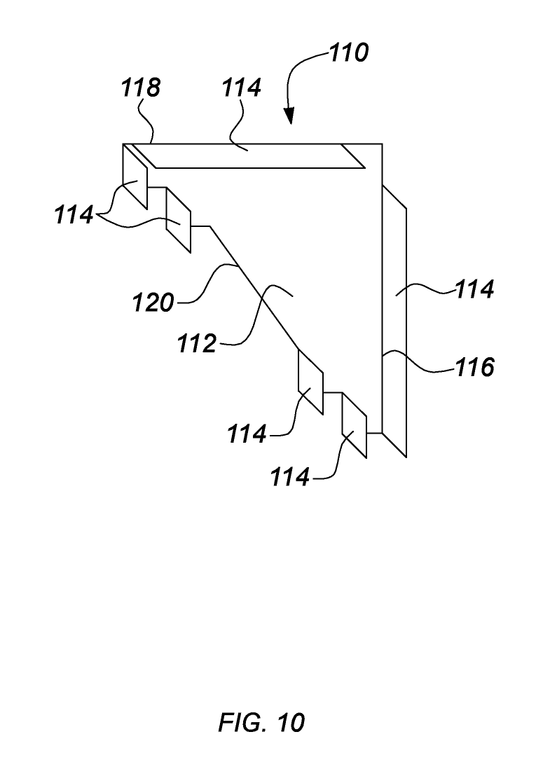

Optionally the kit may include a plurality of end caps 110 adapted to enclose the area behind the pliable panel 60 so as enclosed the space 61 behind the pliable panel for the location of electronics on the like. As illustrated in FIG. 10, the end cap 110 may comprise a substantially planer member 112 having a plurality of tabs 114 extending therefrom. The planar member 112 extends between first and second edges, 116 and 118, respectively and a leading profile edge 120. The leading profile edge 120 is shaped to correspond to the base and distal end brackets 21 and 50 pliable panel 60. The base bracket 21, distal end bracket 50 and pliable panel 60 may be formed of any suitable material, such as, by way of non-limiting example, sheet metal, plastic or fibre reinforced plastic.

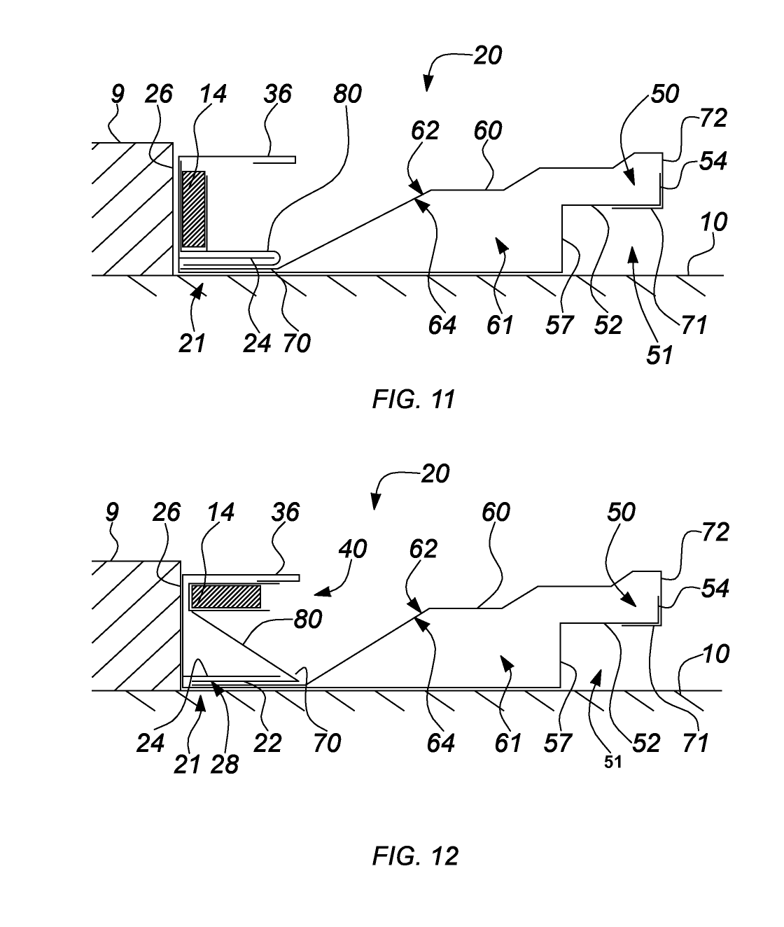

Turning now to FIGS. 11 through 16, according to an optional embodiment of the present invention, the apparatus 20 may be applied around the edge of building trim such that the distal end bracket is also secured to the same wall surface as the base bracket, such as for use around doors, windows and the like.

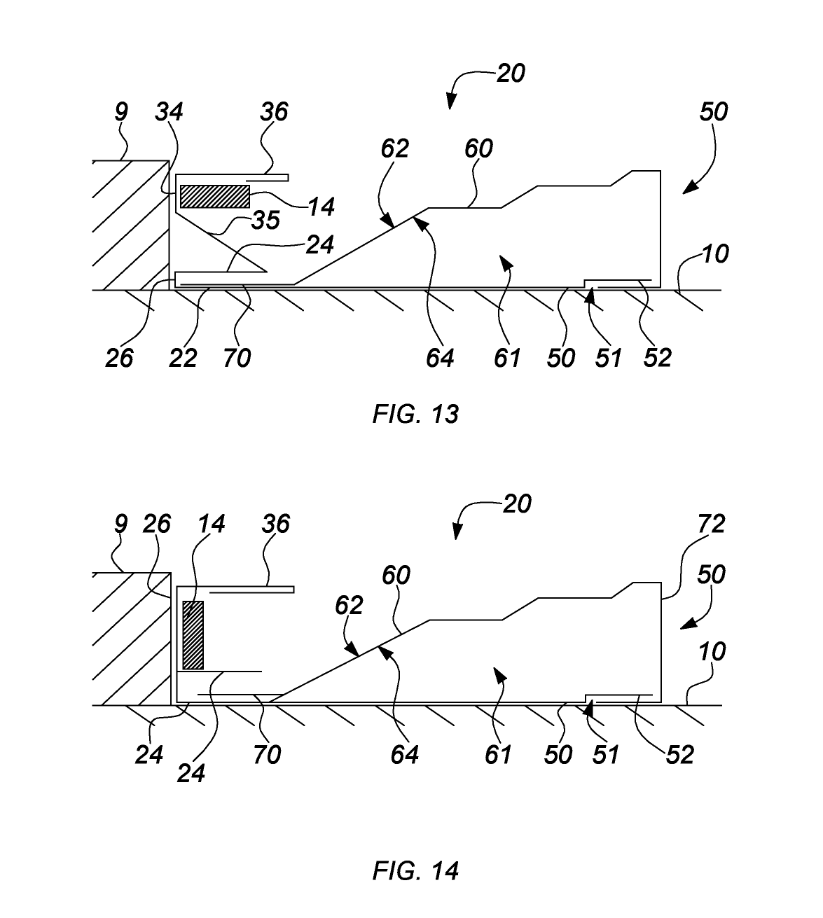

Turning now to FIGS. 11 through 14, the apparatus 20 may be adapted for use applied to a single vertical surface 10 proximate to a protrusion, such as by way of non-limiting example, around a door or window frame 9 or the like. In such embodiments, the distal end bracket 50 will be adapted to extend from and be secured to the vertical surface 10. As illustrated, the top panel 52 may be adapted to have a jog portion 57 therein so as to provide a space 51 therebehind. The space 51 permits a return portion 71 at the distal end of the pliable panel 60 to be located thereunder as illustrated in FIGS. 11 through 14. As illustrated in FIGS. 11 through 14, for use along a common horizontal surface the second engaging portion 72 is also oriented to be substantially perpendicular to the vertical surface 10. The space 51 may be selected to receive the return portion 71 only therein as illustrated in FIGS. 13 and 14 or may optionally sized to overly an adjacent siding panel as illustrated in FIGS. 11 and 12.

As further illustrated in FIGS. 11 through 14, the base bracket 21 may also be adapted such that the front panel 24 extends from a common base panel 26 as illustrated in FIGS. 11, 12 and 14 thereby dividing the bottom channel 28 and light channel 40 from each other. As illustrated in FIG. 13, the jog panel 34 and front panel 24 may optimally include a diagonal plate extending therebetween 35. As illustrated in FIGS. 11 and 12, a clip 80 as described above may also be utilized. As illustrated in FIGS. 15 and 16, the second engaging portion 72 may optionally be secured to the distal end bracket 50 by a fastener, such as a screw or the like. Additionally, the front panel 24 of the base bracket may be omitted such that the pliable panel 60 is adapted to bear against the clip 80 within the light channel 40 and retain it therein.

While specific embodiments of the invention have been described and illustrated, such embodiments should be considered illustrative of the invention only and not as limiting the invention as construed in accordance with the accompanying claims.

What is claimed is:

1. A kit for locating decorative lighting on a building, the kit comprising:
a base bracket securable to a vertical surface of said building, said base bracket having a channel sized and shaped to contain an elongate lighting source;
a distal end brace securable to said building at a location distal to said base bracket; and
a pliable panel having a reflective surface thereon, said flexible panel extending between first and second edges wherein said first edge is adapted to engage with said distal end brace and wherein said second edge is adapted to engage within said channel of said base bracket between a position for said lighting source and said wall of said building.

2. The apparatus of claim 1 wherein said distal end bracket is adapted to be secured to said vertical surface of said building.

3. The apparatus of claim 1 wherein said distal end bracket is adapted to be secured to a downwardly oriented horizontal surface of said building at a location above said base bracket.

4. The apparatus of claim 1 wherein said base bracket is formed of sheet metal.

5. The apparatus of claim 1 wherein said pliable panel is formed of sheet metal.

6. The apparatus of claim 1 wherein said distal bracket is formed of a block around which said first edge of said pliable panel extends.

7. The apparatus of claim 4 wherein said distal bracket is formed of sheet metal.

8. The apparatus of claim 7 wherein said distal bracket and said bases bracket are formed of a continuous sheet.

9. The apparatus of claim 8 wherein said continuous sheet is formed of a horizontal portion extending from said distal end brace and a vertical portion extending from said base bracket.

10. The apparatus of claim 9 wherein said continuous sheet includes a truncating section between said horizontal and vertical portions.

11. The apparatus of claim 1 wherein said channel includes a light retaining portion and a slot between said light retaining portion and a wall engaging portion.

12. The apparatus of claim 11 wherein said slot is sized to receive said second edge of said pliable panel.

13. The apparatus of claim 12 wherein said slot includes a retaining block therein which is fastenable to said wall with fasteners.

14. The apparatus of claim 1 wherein further comprising a plurality of clips adapted to be secured to said elongate lighting source wherein said plurality of clips are adapted to be secured within said channel.

15. The apparatus of claim 14 wherein each clip includes a clamping portion and a retaining portion adapted to be frictionally engaged within said channel.

16. The apparatus of claim 15 wherein said clamping portion is perpendicular to said retaining portion.

17. The apparatus of claim 15 wherein said clamping portion is parallel to said retaining portion.

18. The apparatus of claim 17 wherein said clip has a substantially n-shaped cross section.
